(19) United States
(12) Patent Application Publication
(10) Pub. No.: US 2022/0400899 A1
(43) Pub. Date: Dec. 22, 2022

(54) GRILL BODY STRUCTURE OF PELLET GRILL

(71) Applicant: NINGBO AGSUN PRODUCTS,INC., CIXI (CN)

(72) Inventors: Xuefei Mao, CIXI (CN); Jinsheng Wu, CIXI (CN); Xianghua Liu, CIXI (CN)

(73) Assignee: NINGBO AGSUN PRODUCTS,INC., CIXI (CN)

(21) Appl. No.: 17/893,198

(22) Filed: Aug. 23, 2022

(30) Foreign Application Priority Data
Jul. 15, 2022 (CN) 202221841970.0

(51) Int. Cl. A47J 37/07

(52) U.S. Cl. CPC A47J 37/0704

(57) ABSTRACT

The present invention discloses a grill body structure of a pellet grill, in which a first plate surface of a fixture is assembled with an end shell by first fasteners; a second plate surface of the fixture is assembled with the end shell and a side plate by second fasteners to facilitate splicing and combination of a grill body; and the first fasteners and the second fasteners are externally disposed, and a positioning groove and the fixture separate the fasteners from a heating cavity to achieve heat insulation and improve heat insulation performance in the grill body; and disposition of the fixture is beneficial to improving structural strength of a connection between the end shell and the side plate and improving stability of the structure, and the form of detachable assembly facilitates transportation and carrying.

### TECHNICAL FIELD

The present invention pertains to the technical field of barbecue grills, and specifically pertains to a grill body structure of a pellet grill.

### BACKGROUND

Barbecue grills are often used for grilling meat and vegetables, and characterized by simple installation and being suitable for multi-person outdoor or family gatherings, so they are popular with most people. Pellet grills, also known as biomass pellet grills, use biomass pellets as a fuel to heat food. They use pellets made of sawdust or straw as the fuel, which is characterized by energy saving, environmental protection, high thermal efficiency. In addition, there is only a small amount of powdery residue after full combustion of the biomass pellet fuel, which realizes cleaner, easier and simpler use.

Existing pellet grills generally include two types: welded grill bodies and traditional spliced grill bodies. The welded grill bodies have the problems of inconvenient disassembly and maintenance and space occupation, resulting in inconvenient use, whereas the conventional spliced grill bodies are generally detachably assembled at edges by screws, resulting in poor stability of the grill bodies due to poor structural strength of connections.

### SUMMARY

In view of the above analysis, the present invention proposes a grill body structure of a pellet grill to solve the deficiencies of the prior art.

The present invention is mainly achieved by the following technical scheme:

The present invention provides a grill body structure of a pellet grill which comprises two end plates disposed opposite to each other and a side plate, where the side plate is disposed between the end plates to form a heating cavity with an opening at a front end, each of the end plates comprises an end shell and a fixture, the fixture comprises a first plate surface and a second plate surface vertically connected to each other, the end shell is provided with a positioning groove so as to form an end wall and a side wall, the first plate surface is detachably assembled with the end wall of the positioning groove by a plurality of external first fasteners, the second plate surface is disposed close to the side wall of the positioning groove or closely clings to the side wall of the positioning groove, and both sides of the side plate are detachably assembled with the second plate surface and the side wall of the positioning groove by a plurality of external second fasteners respectively.

The first plate surface of the fixture is assembled with the end shell by the first fasteners, and the second plate surface of the fixture is assembled with the end shell and the side plate by the second fasteners, which facilitate splicing and combination of a grill body. In addition, the first fasteners and the second fasteners are externally disposed, and the positioning groove and the fixture separate the fasteners from the heating cavity to achieve heat insulation and improve heat insulation performance in the grill body. Moreover, disposition of the fixture is beneficial to improving structural strength of a connection between the end shell and the side plate and improving stability of the structure, and the form of detachable assembly facilitates transportation and carrying.

Further, each of the end plates further comprises a cover, and the cover is disposed apart from the end shell to form a first heat insulating space disposed apart from the heating cavity in a mating manner; the fixture further comprises a third plate surface connected with the second plate surface, and the third plate surface is disposed parallel to the first plate surface; and the cover is detachably assembled with at least one of the third plate surface and the end shell by a third fastener.

The cover further isolates heat and reduces temperature on a surface of the end shell, which also improves the heat insulation performance in the grill body.

Further, the side plate is disposed in a gap between the second plate surface and an inner side wall of the positioning groove. The second plate surface and the inner side wall of the positioning groove produce a guiding effect, which results in easy mounting of the side plate and more compact connection between structures, thus avoiding loosening.

Further, the side plate comprises a bottom plate and a back plate which abut against each other, both sides of the bottom plate and the back plate are disposed between the end plates and are assembled with the end shell and the fixture by the second fasteners, a second end portion of the back plate is detachably assembled with a first end portion of the bottom plate by a fourth fastener, and a first end portion of the back plate is disposed apart from a second end portion of the bottom plate to mate with inner wall edges of the end plates to form the opening. The split-type design of the side plate further facilitates the mounting and processing of the side plate.

Further, the grill body structure further comprises an inner lining plate detachably mounted on an inner wall of the side plate by a fifth fastener or the fourth fastener, and both ends of the inner lining plate is disposed between the inner walls of the end plates.

Further, a first support portion is disposed between the inner lining plate and the back plate, so that a second heat insulating space separated from the heating cavity is formed between the inner lining plate and the back plate. The first support portion is provided for improving the structural strength of the side plate, and the second heat insulating space separates the heat inside the heating cavity from the outside to improve the heat insulation performance inside the grill body.

Further, the inner lining plate is provided with a convex surface, and the convex surface mates with an inner wall of the back plate; alternatively, the back plate is provided with a convex surface, and the convex surface mates with an inner wall of the inner lining plate. The convex surface mates with the back plate or the inner lining plate such that the connection between the inner lining plate and the back plate is more stable, which improves the structural strength and facilitates the mounting.

Further, the first support portion comprises a first convex edge and a second convex edge, the first convex edge is oppositely disposed on the inner lining plate, and the second convex edge is oppositely disposed on the inner wall of the back plate, and the first convex edge and the second convex edge abutting against each other are detachably assembled by the fifth fastener.

Further, the bottom plate is provided with a third convex edge abutting against the corresponding second convex edge on the back plate, and the first convex edge, the second convex edge and the third convex edge at a connection between the bottom plate and the back plate are detachably assembled by the fifth fastener. The number of fasteners used can be reduced to improve mounting efficiency.

Further, a fourth convex edge is provided on a top inner edge of the positioning groove, and an edge of the cover is detachably assembled with the fourth convex edge by the third fastener so that the connection among structures of the end plates is more reliable.

Compared with the prior art, the technical scheme of the present invention has the following beneficial effects:

The grill body structure of a pellet grill described herein can be spliced and combined in a more convenient manner, which can effectively achieve heat insulation between the end shell and the heating cavity, facilitate disassembly and replacement of the end shell, enhance the structural strength of the connection between the end shell and the side plate, improve the stability of the structure, and facilitate transportation and carrying.

### BRIEF DESCRIPTION OF THE DRAWINGS

In order to illustrate the technical schemes of embodiments of the present invention more clearly, the following briefly introduces the accompanying drawings used in the description of the embodiments. It is apparent that the accompanying drawings in the following description only illustrate some embodiments of the present invention, and other drawings can also be obtained by those of ordinary skill in the art according to these drawings without any creative effort.

FIG. 1 is a perspective view (I) of a grill body structure of a pellet grill according to an embodiment of the present invention;

FIG. 2 is a perspective view (II) of a grill body structure of a pellet grill according to an embodiment of the present invention;

FIG. 3 is a side view of a grill body structure of a pellet grill according to an embodiment of the present invention;

FIG. 4 is a top view of a grill body structure of a pellet grill according to an embodiment of the present invention;

FIG. 5 is an A-A sectional view of FIG. 3;

FIG. 6 is an enlarged view of a portion C of FIG. 5;

FIG. 7 is an enlarged view of a portion D of FIG. 5;

FIG. 8 is a B-B sectional view of FIG. 4; and

FIG. 9 is an exploded view of a grill body structure of a pellet grill according to an embodiment of the present invention.

### REFERENCE NUMERALS ARE AS FOLLOWS

1. end plate, 1a. first through hole, 1b. second through hole, 11. end shell, 11a. positioning groove, 11b. fourth convex edge, 12. fixture, 121. first plate surface, 122. second plate surface, 123. third plate surface, 13. cover, 13a. notch, 131. third support portion, 14. first heat insulating space, 15. second support portion, 2. side plate, 21. bottom plate, 21a. ash falling hole, 21b, ash clearing hole, 21c. oil discharge hole, 211. third convex edge, 22. back plate, 3. heating cavity, 3a. opening, 4. first fastener, 5. second fastener, 6. third fastener, 8. fifth fastener, 9. inner lining plate, 91. first support portion, 911. first convex edge, 912. second convex edge, 92. second heat insulating space, 93. convex surface.

### DESCRIPTION OF THE EMBODIMENTS

In order to enable those skilled in the art to better understand the present invention and thus to more clearly define the scope of protection of the present invention, the present invention is described in detail below with respect to certain specific embodiments of the present invention. It should be noted that the following are only some specific embodiments of the inventive concept and are only part of the embodiments of the present invention, in which specific and direct description of relevant structures is merely illustrated for understanding the present invention, and the specific features do not, of course, directly limit the scope of the present invention. Conventional choices and substitutions made by those skilled in the art under the guidance of the inventive concept should be regarded to fall within the scope of the present invention.

The present invention is further described in conjunction with the accompanying drawings and specific embodiments.

### Embodiment 1

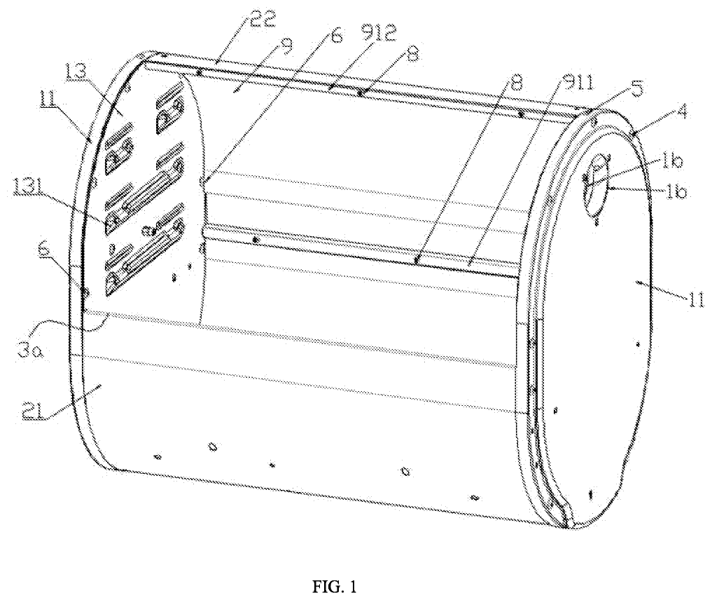

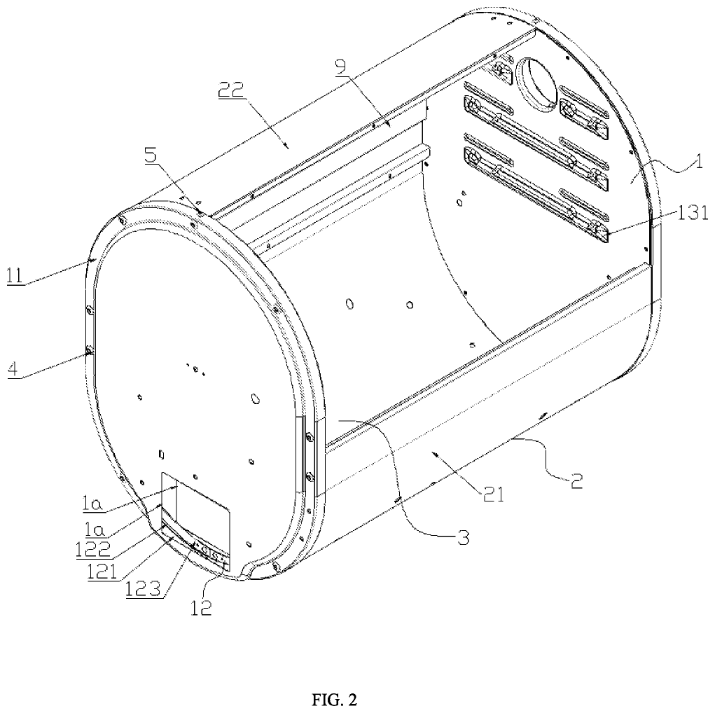

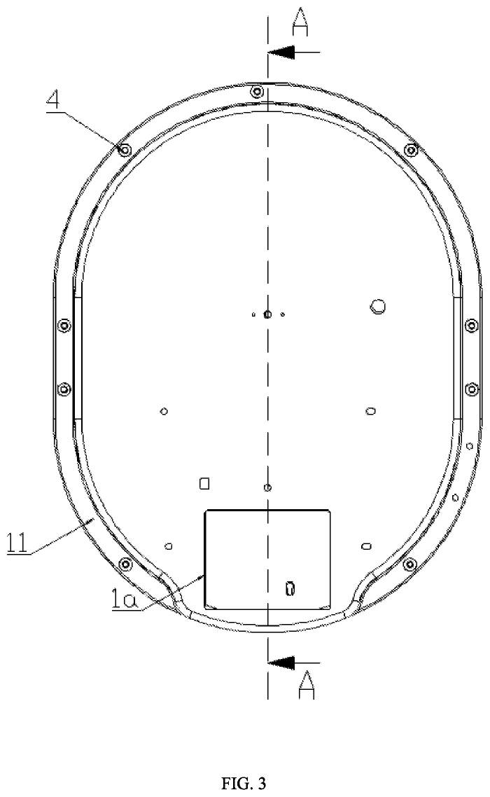

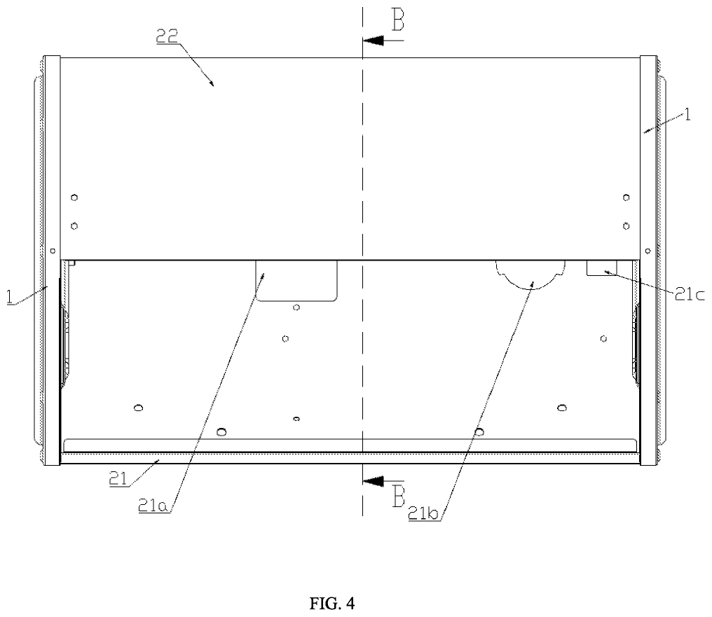

As shown in FIGS. 1 to 4, the present invention provides a grill body structure of a pellet grill, which comprises two end plates 1 disposed opposite to each other, and a side plate 2 disposed between the end plates 1 to form a heating cavity 3 with an opening 3a at a front end.

Each of the end plates 1 comprises an end shell 11 and a fixture 12, the fixture 12 comprises a first plate surface 121 and a second plate surface 122 vertically connected to each other; the end shell 11 is provided with a positioning groove 11a so as to form an end wall and a side wall; the first plate surface 121 is detachably assembled with the end wall of the positioning groove 11a by a plurality of external first fasteners 4; the second plate surface 122 is disposed close to the side wall of the positioning groove 11a or closely clings to the side wall of the positioning groove 11a; and both sides of the side plate 2 are detachably assembled with the second plate surface 122 and the side wall of the positioning groove 11a by a plurality of external second fasteners 5 respectively.

In the present embodiment, the side plate 2 is disposed in a gap between the second plate surface 122 and an inner side wall of the positioning groove 11a.

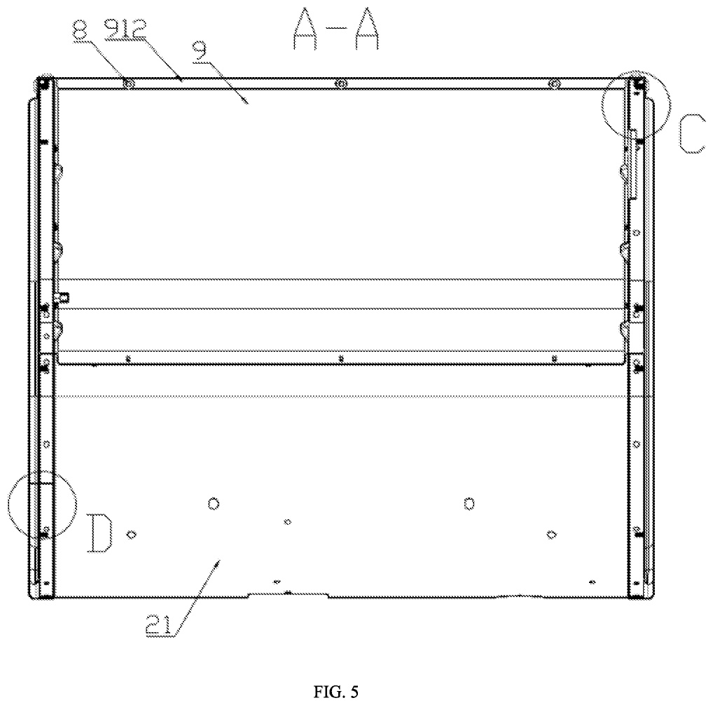

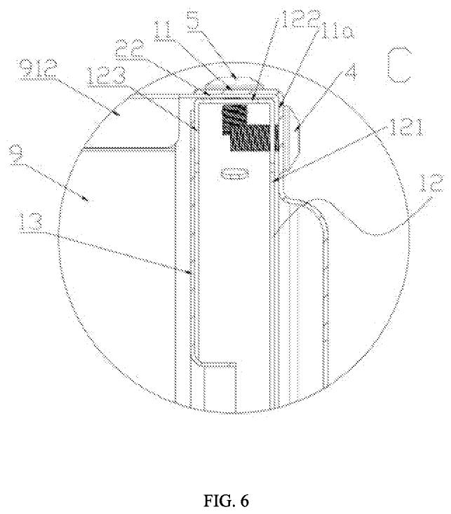

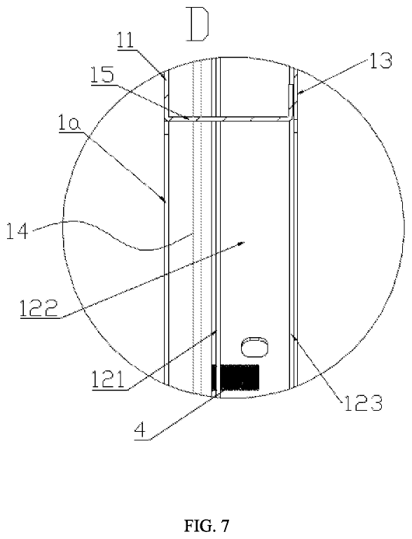

As shown in FIGS. 5 to 7, in particular, each of the end plates 1 further comprises a cover 13, the cover 13 is disposed apart from the end shell 11 to form a first heat insulating space 14 disposed apart from the heating cavity 3 in a mating manner, the fixture 12 further comprises a third plate surface 123 connected with the second plate surface 122, the third plate surface 123 is disposed parallel to the first plate surface 121, and the cover 13 is detachably assembled with at least one of the third plate surface 123 and the end shell 11 by a third fastener 6.

In the present embodiment, the cover 13 is located in the heating cavity 3, the cover 13 is detachably assembled with the third plate surface 123 and the end shell 11 by the third fastener 6, a fourth convex edge 11b is provided on a top inner edge of the positioning groove 11a, an edge of the cover 13 is detachably assembled with the fourth convex edge 11b by the third fastener 6, and the fourth convex edge 11b corresponds to the opening 3a.

In the present embodiment, the fixture 12 has a U-shaped cross section and is disposed on an inner wall edge of the positioning groove 11a. The fixture 12 extends in a circular arc, and may be formed as a single body or a plurality of separate circular arcs abutting against each other. The fixture 12 may also be provided in a one-piece or split ring shape, in which case the fourth convex edge 11b is not required.

In the present embodiment, outer side walls of the covers 13 are correspondingly provided with a third support portion 131 for supporting a grill or a grilling net, the end shell 11 on one side of the side plate 2 and a bottom of the cover 13 are correspondingly provided with a first through hole 1a, the first through hole la of the cover 13 is used for mounting a feeder of the pellet grill, a second support portion 15 is disposed between the end shell 11 and the cover 13, the second support portion 15 is disposed at an upper edge of the first through hole 1a on the end shell 11 and abuts against a side wall at the upper edge of the first through hole 1a on the cover 13, and the second support portion 15 is an L-shaped plate; and the end shell 11 on the other side of the side plate 2 and a top of the cover 13 are correspondingly provided with a second through hole 1b for mounting a flue pipe.

Preferably, the side plate 2 comprises a bottom plate 21 and a back plate 22 which abut against each other, both sides of the bottom plate 21 and the back plate 22 are disposed between the end plates 1 and are assembled with the end shell 11 and the fixture 12 by the second fasteners 5, a second end portion of the back plate 22 is detachably assembled with a first end portion of the bottom plate 21 by a fourth fastener, and a first end portion of the back plate 22 is disposed apart from a second end portion of the bottom plate 21 to mate with inner wall edges of the end plates 1 to form the opening 3a.

In the present embodiment, the bottom plate 21 extends to a front of the end shell 11, i.e., a bottom of the fourth convex edge 11b; the back plate 22 extends to a top of the end shell 11, i.e., a top of the fourth convex edge 11b; the bottom plate 21 and the back plate 22 are disposed clamped between an inner side wall of the end shell 11 and the second plate surface 122; and a bottom of the bottom plate 21 is provided with an ash falling hole 21a, an ash clearing hole 21b and an oil discharge hole 21c.

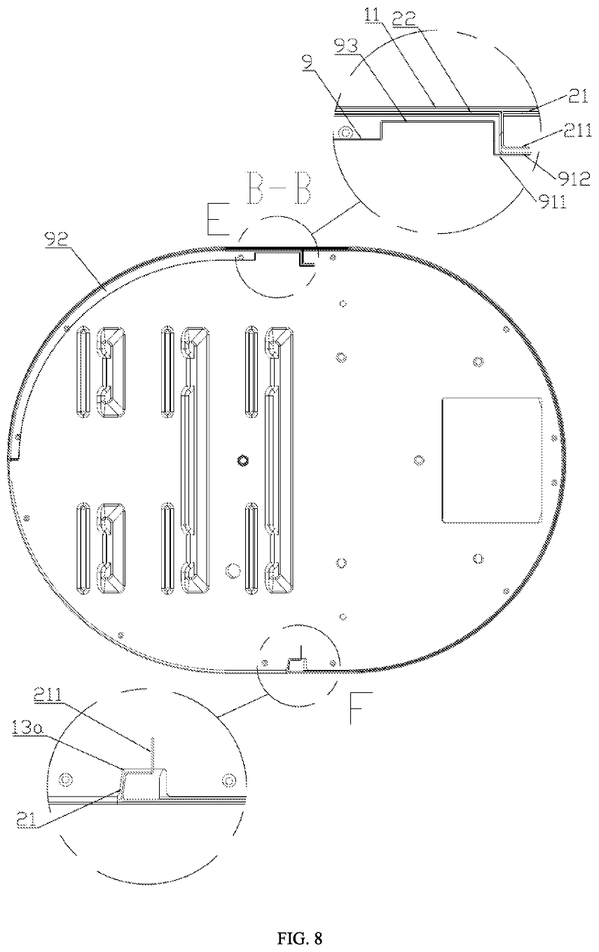

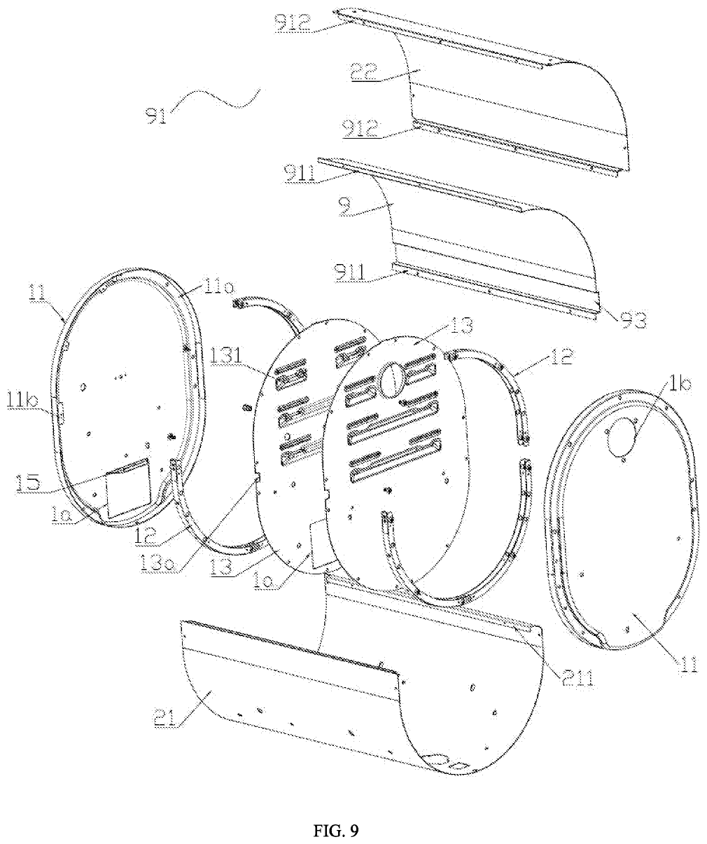

As shown in FIGS. 8 and 9, in particular, the grill body structure further comprises an inner lining plate 9 detachably mounted on an inner wall of the side plate 2 by a fifth fastener 8 or the fourth fastener, and both ends of the inner lining plate 9 is disposed between the inner walls of the end plates 1. A first support portion 91 is disposed between the inner lining plate 9 and the back plate 22, so that a second heat insulating space 92 separated from the heating cavity 3 is formed between the inner lining plate 9 and the back plate 22.

In the present embodiment, the inner lining plate 9 is disposed between the covers 13, the inner lining plate 9 is provided with a convex surface 93, and the convex surface 93 mates with an inner wall of the back plate 22. Alternatively, the back plate 22 is provided with a convex surface 93, and the convex surface 93 mates with an inner wall of the inner lining plate 9. Mating herein means that the convex surface 93 abuts against or has a certain gap from the inner lining plate 9 or the back plate 22.

Preferably, the first support portion 91 comprises a first convex edge 911 and a second convex edge 912, the first convex edge 911 is oppositely disposed on the inner lining plate 9, and the second convex edge 912 is oppositely disposed on the inner wall of the back plate 22. The bottom plate 21 is provided with a third convex edge 211 abutting against the corresponding second convex edge 912 on the back plate 22, and the first convex edge 911, the second convex edge 912 and the third convex edge 211 at a connection between the bottom plate 21 and the back plate 22 are detachably assembled by the fifth fastener 8.

To further reduce the number of fasteners, in the present embodiment, the back plate 22 and the bottom plate 21 are assembled by the corresponding first convex edge 911 and second convex edge 912, and the connection between the back plate 22 and the bottom plate 21 is connected by a set of fifth fasteners 8.

In the present embodiment, the first convex edge 911 is respectively disposed on upper and lower edges of the inner lining plate 9 and extend along a length direction of the inner lining plate 9, the second convex edge 912 is respectively disposed on upper and lower edges of the back plate 22 and extend along a length direction of the back plate 22, and the third convex edges 211 are disposed on both edges of the bottom plate 21 and extend along a length direction of the bottom plate 21. The second convex edge 912 and the third convex edge 211 are L-shaped, the convex surface 93 has a U-shaped cross section, the convex surface 93 is connected with the corresponding first convex edge 911 to form a step to limit the second convex edge 912 in a mating manner, and the second convex edge 912 limits the corresponding third convex edge 211 on the bottom plate 21. The cover 13 is provided with a notch 13a that mates with the second end portion of the bottom plate 21, and the corresponding third convex edge 211 is close to the cover 13. Since the fixture 12 is connected with the cover 13, the cover 13 is limited by the first convex edge 911, the second convex edge 912 and the third convex edge 211, and the fixture 12 cannot fall off when the end shell 11 is disassembled.

The above-mentioned fasteners are self-tapping screws or internal hexagon screws, and the first fastener 4 and the second fastener 5 are preferably internal hexagon screws. The end shell 11, the fixture 12, the cover 13, the bottom plate 21, the back plate 22 and the inner lining plate 9 are all provided with screw holes for assembly of the fasteners, and some fasteners are omitted in some drawings.

The grill body is painted so that the first fasteners 4 and the second fasteners 5 have different colors from a surface of the grill body, so that the above-mentioned fasteners have a certain decorative effect on the grill body. Specifically, the internal hexagon screws are made of stainless steel, the paint is black, and material and color of the internal hexagon screws and color of the paint can also be adjusted according to needs.

The above description merely illustrates preferred embodiments of the present invention and is not intended to limit the scope of protection of the present invention. All the technical schemes falling within the inventive concept fall within the scope of protection of the present invention. It should be noted that several improvements and refinements can be made to the present invention by those of ordinary skill in the art without departing from the principle of the present invention, and such improvements and refinements shall be considered as within the scope of the present invention.

What is claimed is:

1. A grill body structure of a pellet grill, comprising two end plates disposed opposite to each other and a side plate, wherein the side plate is disposed between the end plates to form a heating cavity with an opening at a front end, each of the end plates comprises an end shell and a fixture, the fixture comprises a first plate surface and a second plate surface vertically connected to each other, the end shell is provided with a positioning groove so as to form an end wall and a side wall, the first plate surface is detachably assembled with the end wall of the positioning groove by a plurality of external first fasteners, the second plate surface is disposed close to the side wall of the positioning groove or closely clings to the side wall of the positioning groove, and both sides of the side plate are detachably assembled with the second plate surface and the side wall of the positioning groove by a plurality of external second fasteners respectively.

2. The grill body structure of a pellet grill of claim 1, wherein each of the end plates further comprises a cover, the cover is disposed apart from the end shell to form a first heat insulating space disposed apart from the heating cavity in a mating manner, the fixture further comprises a third plate surface connected with the second plate surface, the third plate surface is disposed parallel to the first plate surface, and the cover is detachably assembled with at least one of the third plate surface and the end shell by a third fastener.

3. The grill body structure of a pellet grill of claim 2, wherein the side plate is disposed in a gap between the second plate surface and an inner side wall of the positioning groove.

4. The grill body structure of a pellet grill of claim 2, wherein the side plate comprises a bottom plate and a back plate which abut against each other, both sides of the bottom plate and the back plate are disposed between the end plates and are assembled with the end shell and the fixture by the second fasteners, a second end portion of the back plate is detachably assembled with a first end portion of the bottom plate by a fourth fastener, and a first end portion of the back plate is disposed apart from a second end portion of the bottom plate to mate with inner wall edges of the end plates to form the opening.

5. The grill body structure of a pellet grill of claim 4, further comprising an inner lining plate detachably mounted on an inner wall of the side plate by a fifth fastener or the fourth fastener, wherein both ends of the inner lining plate is disposed between the inner walls of the end plates.

6. The grill body structure of a pellet grill of claim 5, wherein a first support portion is disposed between the inner lining plate and the back plate, so that a second heat insulating space separated from the heating cavity is formed between the inner lining plate and the back plate.

7. The grill body structure of a pellet grill of claim 6, wherein the inner lining plate is provided with a convex surface, and the convex surface mates with an inner wall of the back plate; alternatively, the back plate is provided with a convex surface, and the convex surface mates with an inner wall of the inner lining plate.

8. The grill body structure of a pellet grill of claim 6, wherein the first support portion comprises a first convex edge and a second convex edge, the first convex edge is oppositely disposed on the inner lining plate, and the second convex edge is oppositely disposed on the inner wall of the back plate, and the first convex edge and the second convex edge abutting against each other are detachably assembled by the fifth fastener.

9. The grill body structure of a pellet grill of claim 8, wherein the bottom plate is provided with a third convex edge abutting against the corresponding second convex edge on the back plate, and the first convex edge, the second convex edge and the third convex edge at a connection between the bottom plate and the back plate are detachably assembled by the fifth fastener.

10. The grill body structure of a pellet grill of claim 2, wherein a fourth convex edge is provided on a top inner edge of the positioning groove, and an edge of the cover is detachably assembled with the fourth convex edge by the third fastener.
